(19) United States
(12) Patent Application Publication
(10) Pub. No.: US 2025/0222963 A1
(43) Pub. Date: Jul. 10, 2025

(54) ON-ROAD EMERGENCY BEHAVIOR MODALITIES ENABLING FOR AUTONOMOUS VEHICLES

(71) Applicant: Torc Robotics, Inc., Blacksburg, VA (US)

(72) Inventors: William Davis, Blacksburg, VA (US); Joseph R. Fox-Rabinovitz, Blacksburg, VA (US); Akshay Pai Raikar, Blacksburg, VA (US); Justin Yurkanin, Blacksburg, VA (US); Pablo Smith, Blacksburg, VA (US); Mihir Deshingkar, Blacksburg, VA (US)

(21) Appl. No.: 18/406,655

(22) Filed: Jan. 8, 2024

(51) Int. Cl. B60W 60/00; B60Q 1/52; B60W 50/00; G06T 17/05; H04W 4/90

(52) U.S. Cl. CPC B60W 60/007; B60Q 1/52; G06T 17/05; H04W 4/90; B60W 2050/0095

(57) ABSTRACT

An autonomous vehicle including one or more sensors positioned on a body of the autonomous vehicle, at least one processor, and at least one memory storing instructions is disclosed. The instructions, when executed by the at least one processor, configure the at least one processor to: (i) receive sensor data from the one or more sensors; (ii) determine, from the sensor data, presence of an emergency situation and absence of an emergency vehicle at a site of the emergency situation; (iii) in accordance with the determining, trigger a first responder mode of the autonomous vehicle; and (iv) initiate one or more actions to assist or protect people or a property at the site of the emergency situation.

### TECHNICAL FIELD

The field of the disclosure relates generally to an autonomous vehicle and, more specifically, enabling on-road emergency behavior modalities in autonomous vehicles by collecting, processing, and using vehicle data for managing autonomous vehicle operations.

### BACKGROUND

Autonomous vehicles employ four fundamental technologies: perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, acceleration, and braking. Information collected using perception and localization technologies may be used not only for safe driving of the autonomous vehicle. Accordingly, there is a need of applications in which the information collected using perception and localization technologies may be used.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an autonomous vehicle including one or more sensors positioned on a body of the autonomous vehicle, at least one processor, and at least one memory storing instructions is disclosed. The instructions, when executed by the at least one processor, configure the at least one processor to: (i) receive sensor data from the one or more sensors; (ii) determine, from the sensor data, presence of an emergency situation and absence of an emergency vehicle at a site of the emergency situation; (iii) in accordance with the determining, trigger a first responder mode of the autonomous vehicle; and (iv) initiate one or more actions to assist or protect people or a property at the site of the emergency situation.

In another aspect, a computer-implemented method is disclosed. The computer-implemented method includes (i) receiving sensor data from one or more sensors positioned on a body of an autonomous vehicle; (ii) based on the sensor data, determining presence of an emergency situation and absence of an emergency vehicle at a site of the emergency situation; (iii) in accordance with the determining, triggering a first responder mode of the autonomous vehicle; and (iv) initiating one or more actions to assist or protect people or a property at the site of the emergency situation.

In yet another aspect, a non-transitory computer-readable medium (CRM) embodying programmed instructions is disclosed. The instructions, when executed by at least one processor of an autonomous vehicle, cause the at least one processor to perform operations including (i) receiving sensor data from one or more sensors positioned on a body of the autonomous vehicle; (ii) based on the sensor data, determining presence of an emergency situation and absence of an emergency vehicle at a site of the emergency situation; (iii) in accordance with the determining, triggering a first responder mode of the autonomous vehicle; and (iv) initiating one or more actions to assist or protect people or a property at the site of the emergency situation.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an example autonomous driving system;

FIG. 3 is a block diagram of an example computing device;

FIG. 4 is a block diagram of an example server computing device; and

FIG. 5 is a flow-chart of an example method being performed by the example autonomous driving system shown in FIG. 2.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver for operating the semi-autonomous vehicle.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Emergency services: Emergency services include an emergency medical services (EMS) department, a fire department, or a police department.

Mission control: Mission control, also referenced herein as a centralized or regionalized control, is a hub in communication with one or more autonomous vehicles of a fleet. Database or datastore at mission control may store data received from the autonomous vehicles. Mission control may analyze the stored data and identify an emergency situation requiring assistance from emergency services. Mission control also have a human agent, or an artificial intelligence (AI) based agent to help identify and assist people in the identified emergency situation.

First responder mode: First responder mode is a mode in which the autonomous vehicle temporarily suspends its current mission parameters to provide on-site services when an accident or an emergency situation is detected, and presence of emergency personnel is not detected at the site of accident or emergency situation.

Vehicle data: Vehicle data include processed or unprocessed sensor data from one or more sensors positioned in a vehicle (e.g., an autonomous vehicle), or an electronic control unit (ECU)-reported status. Sensor data may be processed by any component of an autonomy stack or an on-board ECU.

Various embodiments described herein are directed to enabling a first-responder mode upon detecting a situation requiring an EMS assistance, or assistance from a police department or a fire department, and if the EMS, fire, or police personnel is not already at the scene. By way of a non-limiting example, enabling the first-responder mode may include (i) pulling the autonomous vehicle (which is an autonomously driving truck) at the scene of emergency to protect people or property from other oncoming traffic; (ii) calling EMS, fire, or police department; (iii) providing emergency supplies as required; or (iv) providing systems or resources to communicate with a human agent or an AI-based agent at mission control.

In some embodiments, the autonomous vehicle may turn blinkers or hazard lights on to notify other road users of the emergency situation at the scene. The autonomous vehicle may also use a loudspeaker to inform of the emergency situation at the scene. The autonomous vehicle may block traffic by positioning the autonomous vehicle itself such that the people and property involved in the emergency situation are protected from oncoming traffic. Since no human crew member is required for driving the autonomous vehicle, and due to heavy mass of the autonomous vehicle that is an autonomously driving truck, the required protection to the people and property may be provided until EMS, police, or fire personnel arrives at the scene.

In some embodiments, using sensors including, but not limited to, one or more cameras, one or more radio detecting and ranging (RADAR) sensors, one or more light detection and ranging (LiDAR) sensors, one or more ultrasound sensors, one or more infrared sensors, one or more inertial navigation systems (INS), or one or more acoustic sensors, more accurate information may be provided to the EMS, police, fire department, or even bystanders to assist the victims. For example, using the one or more cameras, one or more LiDAR sensors, one or more RADAR sensors, one or more ultrasound sensors, or one or more infrared sensors, visual data or in-depth three dimensional (3D) visualizations may be generated, and transmitted to the emergency services to request assistance. The visual data or in-depth 3D visualization may provide a clear picture of damage to vehicles, people, or infrastructure, and may help the emergency services to properly scope the situation and dispatch enough qualified personnel and aid to the scene.

In some embodiments, the autonomous vehicle (or the autonomously driving truck) may store emergency supplies, first-aid kit(s), etc., and may announce using a loudspeaker to notify other passersby or good Samaritans to help the people in need with the emergency supplies, first aid kit(s), etc. Additionally, or alternatively, the autonomous vehicle may announce using the loudspeaker that passerby or good Samaritan contact or communicate with the human agent or AI-based agent at mission control to provide more information to better assist victims. Additionally, or alternatively, in certain situations where critical infrastructure damage is detected, passerby or bystanders may be informed to stay away from the scene until emergency personnel arrive at the scene.

In some embodiments, the first responder mode is automatically enabled, by default, in the autonomous vehicle. However, the first responder mode may be configurable to be a default mode, or enabled on demand (for example, based at least in part on analysis of the sensor data and other programmed schedule or itinerary of the autonomous vehicle). In some embodiments, an owner of a fleet of autonomous vehicles may contact with the cities or state to have the first responder mode enabled on the autonomous vehicle by default, for example, for a fee.

In some embodiments, the autonomous vehicle may collect information regarding geolocation of the scene where the emergency situation occurred. Additionally, or alternatively, visual data or in-depth 3D visualization may be generated from the sensor data. The geolocation information, visual data, or in-depth 3D visualization information may be provided to city or state government, or insurance companies to identify areas that are more prone to accidents or to identify vehicles that are more frequently involved in accidents. The geolocation information, visual data, or in-depth 3D visualization information may be labeled with time synchronized global navigation satellite system (GNSS) position and time data.

In some embodiments, the autonomous vehicle may have digital display device on exterior sides of the autonomous vehicle. Based on analysis of the sensor data, the autonomous vehicle may identify where the accident has occurred and may display appropriate message to other traffic. For example, based on the sensor data, if it determined that the accident occurred in the right most lane, the autonomous vehicle may display a sign to indicate that the right most lane is closed due to an accident. Similarly, if more than one lane is closed due to an accident, the autonomous vehicle may display appropriate sign. If the accident has occurred in a single lane, the autonomous vehicle may stop in the lane of the accident behind the vehicles involved in the accident to protect them from other traffic and display appropriate message on the display device mounted on exterior of the autonomous vehicle. Additionally, or alternatively, in some embodiments, the autonomous vehicle may flash its lights (including lights of the attached trailer, if any), or deploy road markers if available.

In some embodiments, the city and state may have an agreement to receive raw sensor data, or processed data, such as in-depth 3D visualization information or other analysis results, from an owner of a fleet of a plurality of autonomous vehicles. Accordingly, while an autonomous vehicle of the plurality of autonomous vehicles of the fleet is within a boundary of the city or state jurisdiction, the emergency services may configure the first responder mode as enabled, using a data interface. Additionally, or alternatively, the first responder mode may be enabled by default while the autonomous vehicle is within the boundary of the city or state jurisdiction, based at least in part on sensor data identifying geolocation of the autonomous vehicle.

The data interface may be used by the emergency services to collect vehicledata from the autonomous vehicle. By way of a non-limiting example, a human agent, an AI-based agent, or a client computing device at the emergency services, may pull the vehicle data from the autonomous vehicle periodically or in isolated events. Additionally, or alternatively, sensor data may be pulled by the emergency services, when the autonomous vehicle transmits a notification including a geolocation or an emergency situation identified based on analysis of the sensor data and upon determining that no personnel from the emergency services is present at the scene of emergency situation. Additionally, or alternatively, sensor data may be pushed by the autonomous vehicle to the emergency services, when an emergency situation is identified by the autonomous vehicle based on analysis of the sensor data and upon determining that no personnel from the emergency services is present at the scene of emergency situation.

In some embodiments, the emergency services may locate one or more autonomous vehicles of the plurality of autonomous vehicles of the fleet within the boundary of the city or state jurisdiction and collect vehicle data from one or more autonomous vehicles. For example, the vehicle data may include data of one or more cameras (or any other sensor) mounted on an autonomous vehicle of the fleet to assess the emergency situation. Additionally, or alternatively, the emergency services may collect vehicle data of one or more autonomous vehicles of the fleet via mission control (or using computing devices at mission control communicatively coupled with the one or more autonomous vehicles of the fleet). A selection of sensors for collecting or requesting sensor data may be made, depending on situational needs and possibly a subscription service or other contract. Cameras (visible, IR, UV, etc.) to view the scene may be a first choice, but LiDAR, RADAR, and even acoustic sensors such as sonar or ultrasound or microphones may be a choice to receive valuable dimensional or even structural or situations information in some scenarios such as, gunshots or screams.

In some embodiments, the first responder mode may be automatically enabled on one or more autonomous vehicles that are in proximity of the accident site. In the situation when the first responder mode is enabled, the majority of the computing resources of the autonomous vehicle may be made available, and relevant portions of its state (e.g., motion estimation and map localization states) may be stored in a persistent memory and the software stack may be switched to the first responder mode. The first responder mode may allow a different autonomy stack to run, with one or more classical algorithms or machine-learning models trained in identifying aspects of emergency situations, instead of one or more classical algorithms or machine-learning models trained towards driving of the autonomous vehicle.

In some embodiments, visual data may be processed to selectively censor or restrict personal identifying information before the data is transmitted to the emergency services or an insurance company. The personal identifying information may include, but is not limited to, faces, license plates, and other identifiers. In some embodiments, the vehicle data may be stored locally in a database or datastore at the autonomous vehicle, and mission control may pull the vehicle data from the autonomous vehicle to store in a database or datastore in a cloud network or at mission control.

In some embodiments, data collected from the one or more autonomous vehicles and stored in a database at mission control or in the cloud network may be used for training one or more machine-learning algorithms or tuning one or more classical algorithms to distinguish and identify a real emergency situation from a non-emergency situation. The algorithms may be trained to identify hazard symbols on vehicles involved in emergency situations, and installed on the autonomous vehicle as part of the stack associated with the first responder mode.

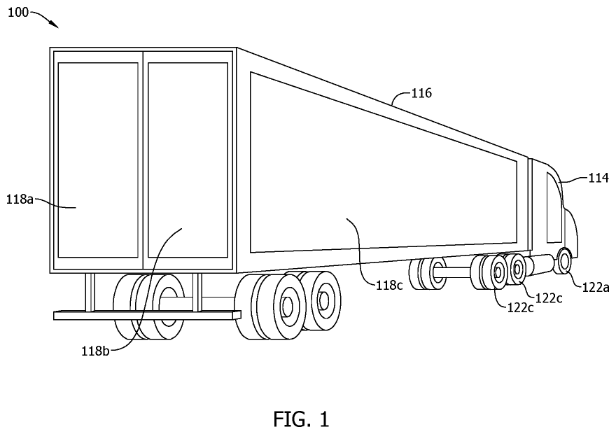

Various embodiments, as described herein, thus enable the autonomous vehicle to provide early assistance to victims of an emergency situation while no personnel from EMS, police, or fire department have reached at the site of the emergency situation. Various embodiments are discussed in more detail below with respect to FIGS. 1-5.

FIG. 1 illustrates an autonomous vehicle 100 that may further be conventionally connected to a single trailer 116 or tandem trailer (not shown) to transport the trailers to a desired location. The vehicle 100 includes a cabin 114 and can be supported by, and steered in, the required direction by front wheels 112a, and rear wheels 112c that are partially shown in FIG. 1. Wheels 112a, 112b are positioned by a steering system. In some embodiments, the steering system may include a steering wheel and a steering column (not shown in FIG. 1). A trailer 116 may be attached to the cabin 114 and may have a plurality of display devices 118a-118c mounted on a plurality of exterior sides of the autonomous vehicle 100. Although only three display devices 118a-118c are shown in FIG. 1, there may be any number of display devices mounted on the plurality of exterior sides of the autonomous vehicle 100.

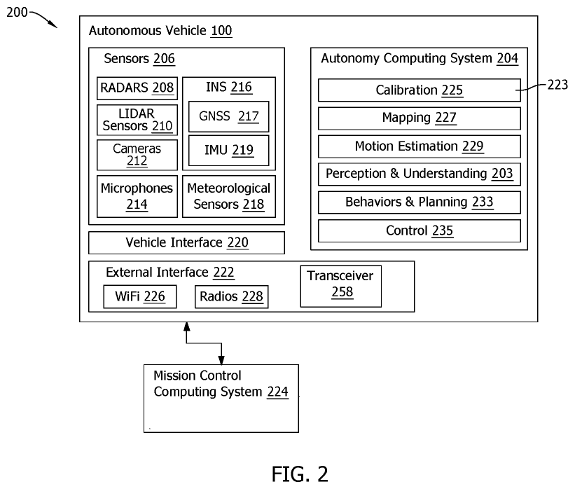

FIG. 2 is a block diagram of an autonomous driving system 200, including an autonomous vehicle 100 (shown in FIG. 1) that is communicatively coupled with mission control computing system 224.

A master control unit (MCU) of the autonomous vehicle 100 may periodically transmit telematics data via one or more antennas (not shown) to mission control (or a mission control computing system) 224. As described herein, the telematics data may include, but is not limited to, location data of the autonomous vehicle 100, speed of the autonomous vehicle 100, vehicle maintenance data corresponding to the autonomous vehicle 100, or sensor data from one or more sensors 206 positioned on the autonomous vehicle 100. Additionally, or alternatively, mission control 224 may request the autonomous vehicle 100 to send the telematics data, or sensor data, and the autonomous vehicle 100 may send the telematics data or sensor data to mission control 224 for analysis and identifying an emergency situation requiring assistance from the emergency services, and no personnel from the emergency services is present at the site of the emergency situation. The MCU may also receive data from one or more sensors such as cameras 212, microphones or acoustic sensors 214, RADAR sensors 208, and LiDAR sensors 210, etc. The data received from the one or more sensors may be analyzed by the MCU of the autonomous vehicle 100 for identifying that an emergency situation exists at a site and determining that no personnel from the emergency services is present at the site of emergency situation.

In some embodiments, the mission control 224, or the mission control computing system 224 may transmit control commands or data to the autonomous vehicle 100, such as navigation commands, and travel trajectories to the autonomous vehicle 100, and may receive telematics data from the autonomous vehicle 100. Additionally, or alternatively, mission control 224 may receive vehicle data from the autonomous vehicle 100, when the autonomous vehicle 100 determines, based upon analysis of the sensor data, that an emergency situation is present and no personnel from the emergency services is present at the site of emergency situation. Mission control 224. Mission control 224 may send commands to the autonomous vehicle to transmit sensor data associated with one or more specific sensors 206 or output of specific modules 223. Mission control may store the sensor data received from the autonomous vehicle 100 and use to train one or more classical algorithms or one or more machine-learning algorithms to identify a real emergency situation and distinguish the real emergency situation from a non-emergency situation. The one or more algorithms may also be trained or tuned to recognize various hazard symbols, and the trained or tuned algorithms may be stored for execution in a software stack that is specially configured for execution when the first responder mode is enabled. Mission control 224 may be the emergency services.

In some embodiments, the autonomous vehicle 100 may further include sensors 206. Sensors 206 may include RADAR sensors 208, LiDAR sensors 210, cameras 212, and acoustic sensors 214. The sensors 206 may further include an inertial navigation system (INS) 216 configured to determine states such as the location, orientation, and velocity of the autonomous vehicle 100. The INS 216 may include at least one global navigation satellite system (GNSS) receivers 217 configured to provide positioning, navigation, and timing using satellites. The INS 216 may also include at least one inertial measurement unit (IMU) 219 configured to measure motion properties such as the angular velocity, linear acceleration, or orientation of the autonomous vehicle 100. The sensors 206 may further include meteorological sensors 218. Meteorological sensors 218 may include temperature sensors, humidity sensors, anemometers, pitot tubes, barometers, precipitation sensors, or a combination thereof. The meteorological sensors 218 are used to acquire meteorological data, such as the humidity, atmospheric pressure, wind, or precipitation, of the ambient environment of autonomous vehicle 100, which may have a profound impact on handling of the emergency situation. Additionally, or alternatively, sensors 206 may also include devices or sensors to detect odor, smoke, airborne chemicals, and other signals that might be relevant in handling an emergency situation.

The autonomous vehicle 100 may further include a vehicle interface 220, which interfaces with an engine control unit (ECU) (not shown) or a MCU (not shown) of autonomous vehicle 100 to control the operation of the autonomous vehicle 100 such as acceleration, braking, signaling, and steering. Upon identifying an emergency situation such as an accident, a fire, a damaged property or road, etc., and upon determining that no personnel from the emergency services is present at the site of the emergency situation, the first responder mode may be triggered, as described herein. By way of a non-limiting example, the vehicle interface 220 may be a controller area network (CAN) bus interface.

The autonomous vehicle 100 may further include external interface 222 configured to communicate with external devices or systems such as another vehicle or mission control computing system 224. The external interface 222 may include Wi-Fi 226, other radios 228 such as Bluetooth, or a suitable wired or wireless transceiver 258 such as a cellular communication device. Data detected by the sensors 206 may be transmitted to the mission control computing system 224 via the external interface 222, or to the ECU or MCU via the vehicle interface 220.

The autonomous vehicle 100 may further include an autonomy computing system 204. The autonomy computing system 204 may control driving of the autonomous vehicle 100 through the vehicle interface 220. The autonomy computing system 204 may operate the autonomous vehicle 100 to drive the autonomous vehicle from one location to another. Additionally, or alternatively, the autonomy computing system 204 may analyze the sensor data and identify an emergency situation. Upon identifying an emergency situation such as, an accident, a fire, a damaged property or road, etc., and upon determining that no personnel from the emergency services is present at the site of the emergency situation, the first responder mode may be triggered, as described herein.

In some embodiments, the autonomy computing system 204 may include modules 223 for performing various functions. Modules 223 may include a calibration module 225, a mapping module 227, a motion estimation module 229, perception and understanding module 203, behaviors and planning module 233, and a control module 235. Perception and understanding module 203 may be configured to analyze data from sensors 206 to identify an object. Modules 223 and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard the autonomous vehicle 100.

Various embodiments described herein for perceiving or identifying objects in the environment of the autonomous vehicle 100 may be implemented as part of the perception and understanding module 203. In some embodiments, based on the data collected from the sensors 206, the autonomy computing system 204 and, more specifically, perception and understanding module 203 senses the environment surrounding autonomous vehicle 100 by gathering and interpreting sensor data. Perception and understanding module 203 interprets the sensed environment to identify an emergency situation, presence or absence of a personnel from the emergency services, victims requiring assistance, damaged property, etc., and may cause the behaviors and planning module 233 to trigger the first responder mode to perform functions described herein to assist during the emergency situation once the first responder mode is enabled. By way of a non-limiting example, perception and understanding module 203 in combination with various sensors 206 (e.g., LiDAR sensors, cameras, RADAR sensors, microphones, etc.) of the autonomous vehicle 100 may identify a scene of an accident, injured people, smoke, fire, distressed voice, damaged property, presence or absence of an emergency vehicle (an ambulance, a fire truck, a police cruiser, etc.), types and license plate information of vehicles involved in the emergency situation, etc.

Mapping module 227 receives data from sensors 206, and in some embodiments from perception module 203, that can be compared to one or more digital maps stored in mapping module 227 to determine where autonomous vehicle 100 is in the world or where autonomous vehicle 100 is on a digital map(s). In particular, mapping module 227 may receive perception data from perception and understanding module 203 or from the various sensors 206 sensing the environment surrounding autonomous vehicle 100 and may correlate features of the sensed environment with details (e.g., digital representations of the features of the sensed environment) on the one or more digital maps. A digital map may have various levels of detail and can be, for example, a raster map, or a vector map. The digital maps may be stored locally on autonomous vehicle 100 or stored and accessed remotely. In at least one embodiment, autonomous vehicle 100 deploys with sufficient stored information in one or more digital map files to complete a mission without connection to an external network during the mission, or to identify a current geolocation of the autonomous vehicle 100.

In the example embodiment, behaviors and planning module 233 may plan and control module 235 may implement one or more behavior-based trajectories to operate the autonomous vehicle 100 similar to a human driver-based operation. The behaviors and planning module 233 and control module 235 use inputs from the perception and understanding module 203 or mapping module 227 to generate trajectories or other planned behaviors. For example, behavior and planning module 233 may generate potential trajectories or actions and select one or more of the trajectories to follow or enact as the vehicle travels along the road. The trajectories may be generated based on proper (i.e., legal, customary, or safe) interaction with other static and dynamic objects in the environment. Behaviors and planning module 233 may generate tactical objectives (e.g., following rules or restrictions) such as, for example, lane changes, stopping at stop signs, etc. Additionally, behavior and planning module 233 may be communicatively coupled to, include, or otherwise interact with motion planners, which may generate paths or actions to achieve tactical objectives. Tactical objectives may further include, for example, reaching a strategic goal while avoiding obstacle collisions, maintaining legal speed limits, exhibiting courtesy, merging, etc. Additionally, or alternatively, behaviors and planning module 233 may determine a list of actions to be performed, for example, by control module 235 during the first responder mode based on analysis of the sensor data and identified severity of the emergency situation.

In the example embodiment, based on the data collected from sensors 206, autonomy computing system 204 is configured to perform analysis of the sensor data, for example in perception and understanding module 203, and enable or trigger the first responder mode, and perform actions to provide assistance according to analysis of the sensor data, for example, in behaviors and planning module 233.

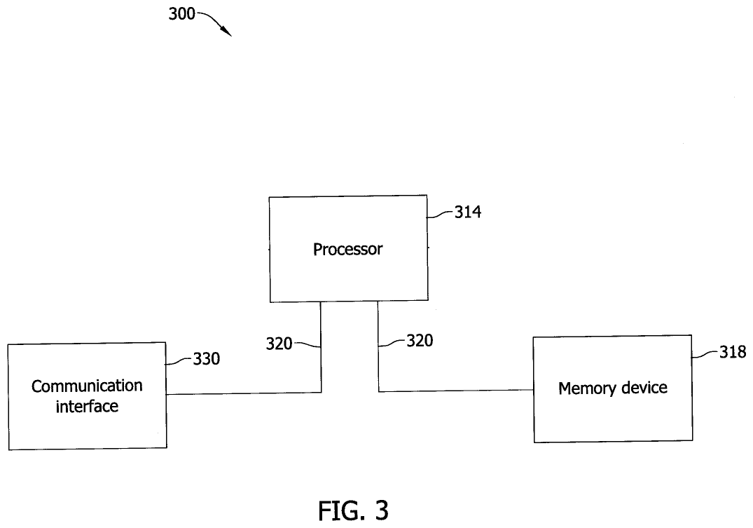

Method operations described herein may be implemented on autonomy computing system 204, or more specifically on perception and understanding module 203 and behaviors and planning module 233. Additionally, or alternatively, the method operations may be performed on an ECU or MCU. Autonomy computing system 204 (or perception and understanding module 203 and behaviors and planning module 233) described herein may be any suitable computing device 300 and software implemented therein. FIG. 3 is a block diagram of an example computing device 300.

Computing device 300 includes a processor 314 and a memory device 318. The processor 314 is coupled to the memory device 318 via a system bus 320. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition and/or meaning of the term “processor.”

In the example embodiment, the memory device 318 includes one or more devices that enable information, such as executable instructions or other data (e.g., sensor data), to be stored and retrieved. Moreover, the memory device 318 includes one or more computer readable media, such as, without limitation, dynamic random access memory (DRAM), static random access memory (SRAM), a solid state disk, or a hard disk. In the example embodiment, the memory device 318 stores, without limitation, application source code, application object code, configuration data, additional input events, application states, assertion statements, validation results, or any other type of data. The computing device 300, in the example embodiment, may also include a communication interface 330 that is coupled to the processor 314 via system bus 320. Moreover, the communication interface 330 is communicatively coupled to data acquisition devices.

In the example embodiment, processor 314 may be programmed by encoding an operation using one or more executable instructions and providing the executable instructions in the memory device 318. In the example embodiment, the processor 314 is programmed to select a plurality of measurements that are received from data acquisition devices.

In operation, a computer executes computer-executable instructions embodied in one or more computer-executable components stored on one or more computer-readable media to implement aspects of the embodiments described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

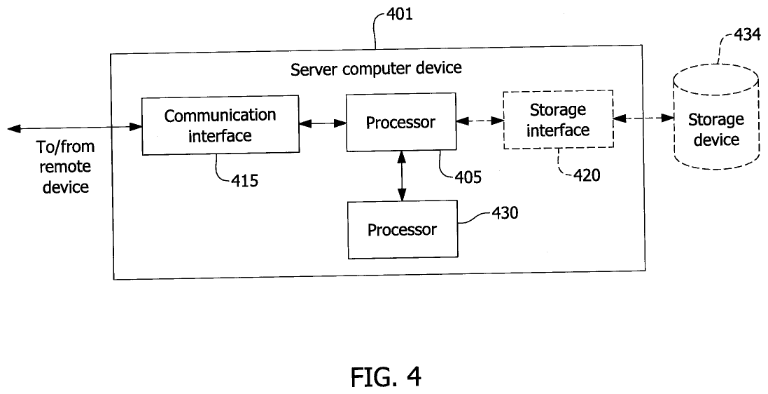

FIG. 4 illustrates an example configuration of a server computer device 401 such as mission control computing system 224. The server computer device 401 also includes a processor 405 for executing instructions. Instructions may be stored in a memory area 430, for example. Processor 405 may include one or more processing units (e.g., in a multi-core configuration). By way of a non-limiting example, in some embodiments, the server computing device 401 may receive sensor data, from the autonomous vehicle 100, for identifying an emergency situation and triggering or enabling the first responder mode of the autonomous vehicle 100, and the processor 405 may accordingly trigger or enable the first responder mode based on the sensor data according to the embodiments described herein.

Processor 405 is operatively coupled to a communication interface 415 such that server computer device 401 is capable of communicating with the autonomous vehicle 100 or another server computer device 401. For example, communication interface 415 may receive data from autonomy computing system 204 or sensors 206, via the Internet or wireless communication.

Processor 405 may also be operatively coupled to a storage device 434. Storage device 434 is any computer-operated hardware suitable for storing and/or retrieving data. In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include multiple storage units such as hard disks and/or solid state disks in a redundant array of independent disks (RAID) configuration. storage device 434 may include a storage area network (SAN) and/or a network attached storage (NAS) system. In some embodiments, storage device 434 may be a database or datastore in a cloud network.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

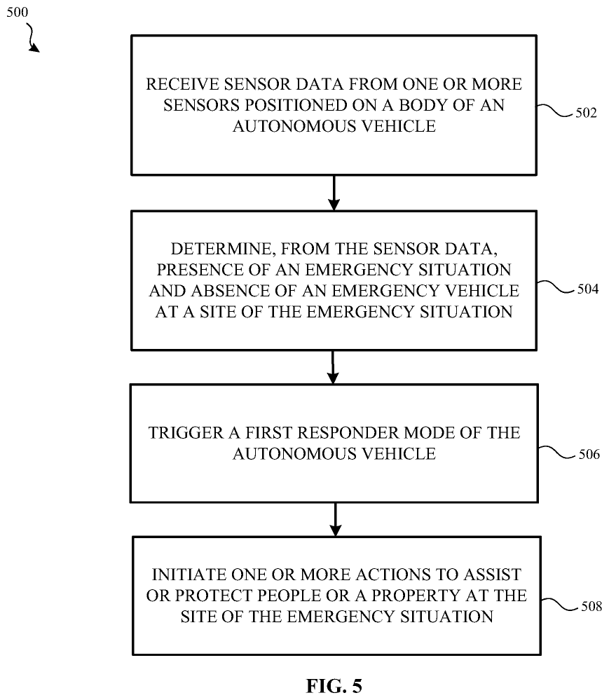

FIG. 5 is a flow-chart 500 of an example method being performed by the example autonomous driving system shown in FIG. 2. As shown in FIG. 5, sensor data from one or more sensors positioned on a body of the autonomous vehicle 100 may be received 502. As described herein, the one or more sensors may include at least one or more acoustic sensors, one or more cameras, one or more RADAR sensors, or one or more LiDAR sensors. Based on analysis of the received sensor data, presence of an emergency situation and absence of an emergency vehicle at a site of the emergency situation may be determined 504. By way of a non-limiting example, the received sensor data may be processed or analyzed using one or more machine-learning algorithms trained to identify an emergency situation including, but not limited to, an accident, a fire, a smoke, a damaged property, or an injured person. The one or more machine-learning algorithms may also be trained to determine absence of the emergency vehicle at the site of the emergency situation. The one or more machine-learning models may be trained to determine presence of the emergency situation using acoustic or visual sensor data collected from the one or more RADAR sensors, the one or more LiDAR sensors, the one or more cameras, or the one or more microphones of one or more autonomous vehicles.

Upon determining 504 presence of the emergency situation and absence of the emergency vehicle at the site of the emergency situation, a first responder mode of the autonomous vehicle may be triggered, activated, or enabled 506. In some embodiments, when the first responder mode of the autonomous vehicle is triggered, the sensor data including a geolocation of the site of the emergency situation, and audio or visual data corresponding to the emergency situation may be transmitted to a computing system (e.g., a computing device at mission control, or emergency services), and instructions to transmit specific sensor data or perform the one or more actions to assist or protect the people or the property at the site of the emergency situation may be received from the computing system. Additionally, or alternatively, the sensor data may be processed to remove personal identifying information from the sensor data before transmitting the sensor data to the computing system. As described herein, while the first responder mode is enabled, the normal functionality of the autonomous vehicle may be suspended, disabled, or suppressed.

While the first responder mode is enabled, one or more actions may be initiated 508 to assist or protect people or a property at the site of the emergency situation. By way of a non-limiting example, the one or more actions initiated 508 to assist or protect the people or property may include (i) pulling the autonomous vehicle in a driving lane or a shoulder at an angle or straight; (ii) displaying one or more messages on one or more display devices mounted on one or more exterior sides of the autonomous vehicle 100 to alert a passerby of the emergency situation or to request help; or (iii) initiating a two-way communication between the passerby and an agent at a mission control or emergency services.

In some embodiments, the first responder mode may be disabled or deactivated when mission control or the emergency services may transmit a command (e.g., an abort command) to the autonomous vehicle, or when the autonomous vehicle determines that the personnel from the emergency services has arrived at the site of the emergency situation or close to arrive at the site of the emergency situation. Additionally, or alternatively, the first responder may be disabled or deactivated when the personnel from the emergency services provides an audio command or a command through a digital interface to leave the autonomous vehicle from the site of the emergency situation. By way of a non-limiting example, the personnel from the emergency services may ask mission control to send the command to the autonomous vehicle to deactivate or disable the first responder mode.

Various embodiments, as described herein, thus enable the autonomous vehicle to provide early assistance to victims of an emergency situation while no personnel from EMS, police, or fire department have reached at the site of the emergency situation.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle, comprising:
one or more sensors positioned on a body of the autonomous vehicle;
at least one processor;
at least one memory storing instructions, which, when executed by the at least one processor, configure the at least one processor to:
receive sensor data from the one or more sensors;
determine, from the sensor data, presence of an emergency situation and absence of an emergency vehicle at a site of the emergency situation;
in accordance with the determining, trigger a first responder mode of the autonomous vehicle; and
initiate one or more actions to assist or protect people or a property at the site of the emergency situation.

2. The autonomous vehicle of claim 1, further comprising a transceiver, and wherein the at least one processor is further configured to:
transmit, via the transceiver to a computing system, the sensor data including a geolocation of the site of the emergency situation, and audio or visual data corresponding to the emergency situation; and
receive, via the transceiver from the computing system, instructions to transmit specific sensor data or perform the one or more actions to assist or protect the people or the property at the site of the emergency situation.

3. The autonomous vehicle of claim 2, wherein the at least one processor is further configured to:
process the sensor data to remove personal identifying information from the sensor data before transmitting the sensor data to the computing system.

4. The autonomous vehicle of claim 1, wherein the one or more sensors include at least one or more acoustic sensors, one or more cameras, one or more radio detection and ranging (RADAR) sensors, or one or more light detection and ranging (LiDAR) sensors.

5. The autonomous vehicle of claim 1, wherein the at least one processor is further configured to generate three dimensional (3D) visualization images based on the sensor data from the one or more radio detection and ranging (RADAR) sensors, the one or more light detection and ranging (LiDAR) sensors, or the one or more cameras.

6. The autonomous vehicle of claim 1, further comprising one or more display devices mounted on one or more exterior sides of the autonomous vehicle; and wherein the at least one processor is further configured to initiate the one or more actions to assist or protect the people or property at the site of the emergency situation by performing one or more of:
pulling the autonomous vehicle in a driving lane or a shoulder at an angle or straight;
displaying one or more messages on the one or more display devices to alert a passerby of the emergency situation or to request help; or
initiating a two-way communication between the passerby and an agent at a mission control, a police department, a fire department, or an emergency medical services department.

7. The autonomous vehicle of claim 1, wherein the at least one processor is further configured to:
determine presence of the emergency situation and absence of the emergency vehicle at the site of the emergency situation based on one or more machine-learning models trained to identify the emergency situation including an accident, a fire, a smoke, a damaged property, or an injured person, based at least in part on acoustic data or visual data of the sensor data using the one or more radio detection and ranging (RADAR) sensors, the one or more light detection and ranging (LiDAR) sensors, the one or more cameras, or the one or more microphones.

8. A computer-implemented method comprising:
receiving sensor data from one or more sensors positioned on a body of an autonomous vehicle;
based on the sensor data, determining presence of an emergency situation and absence of an emergency vehicle at a site of the emergency situation;
in accordance with the determining, triggering a first responder mode of the autonomous vehicle; and
initiating one or more actions to assist or protect people or a property at the site of the emergency situation.

9. The computer-implemented method of claim 8, further comprising:
transmitting, via a transceiver of the autonomous vehicle to a computing system, the sensor data including a geolocation of the site of the emergency situation, and audio or visual data corresponding to the emergency situation; and
receiving, via the transceiver from the computing system, instructions to transmit specific sensor data or perform the one or more actions to assist or protect the people or the property at the site of the emergency situation.

10. The computer-implemented method of claim 9, further comprising processing the sensor data to remove personal identifying information from the sensor data before transmitting the sensor data to the computing system.

11. The computer-implemented method of claim 8, wherein the one or more sensors include at least one or more acoustic sensors, one or more cameras, one or more radio detection and ranging (RADAR) sensors, or one or more light detection and ranging (LiDAR) sensors.

12. The computer-implemented method of claim 8, further comprising generating three dimensional (3D) visualization images based on the sensor data from the one or more radio detection and ranging (RADAR) sensors, the one or more light detection and ranging (LiDAR) sensors, or the one or more cameras.

13. The computer-implemented method of claim 8, wherein initiating the one or more actions to assist or protect the people or the property at the site of the emergency situation comprises performing one or more of:
pulling the autonomous vehicle in a driving lane or a shoulder at an angle or straight;
displaying one or more messages on one or more display devices mounted on one or more exterior sides of the autonomous vehicle to alert a passerby of the emergency situation or to request help; or
initiating a two-way communication between the passerby and an agent at a mission control, a police department, a fire department, or an emergency medical services department.

14. The computer-implemented method of claim 8, further comprising determining presence of the emergency situation and absence of the emergency vehicle at the site of the emergency situation based on one or more machine-learning models trained to identify the emergency situation including an accident, a fire, a smoke, a damaged property, or an injured person, based at least in part on acoustic data or visual data of the sensor data using the one or more radio detection and ranging (RADAR) sensors, the one or more light detection and ranging (LiDAR) sensors, the one or more cameras, or the one or more microphones.

15. A non-transitory computer-readable medium (CRM) embodying programmed instructions which, when executed by at least one processor of an autonomous vehicle, cause the at least one processor to perform operations comprising:
receiving sensor data from one or more sensors positioned on a body of the autonomous vehicle;
based on the sensor data, determining presence of an emergency situation and absence of an emergency vehicle at a site of the emergency situation;
in accordance with the determining, triggering a first responder mode of the autonomous vehicle; and
initiating one or more actions to assist or protect people or a property at the site of the emergency situation.

16. The non-transitory CRM of claim 15, wherein the operations further comprising:
transmitting, via a transceiver of the autonomous vehicle to a computing system, the sensor data including a geolocation of the site of the emergency situation, and audio or visual data corresponding to the emergency situation; and
receiving, via the transceiver from the computing system, instructions to transmit specific sensor data or perform the one or more actions to assist or protect the people or the property at the site of the emergency situation.

17. The non-transitory CRM of claim 16, wherein the operations further comprising processing the sensor data to remove personal identifying information from the sensor data before transmitting the sensor data to the computing system.

18. The non-transitory CRM of claim 15, wherein the one or more sensors include at least one or more acoustic sensors, one or more cameras, one or more radio detection and ranging (RADAR) sensors, or one or more light detection and ranging (LiDAR) sensors.

19. The non-transitory CRM of claim 15, wherein the operations further comprising generating three dimensional (3D) visualization images based on the sensor data from the one or more radio detection and ranging (RADAR) sensors, the one or more light detection and ranging (LiDAR) sensors, or the one or more cameras.

20. The non-transitory CRM of claim 15, wherein initiating the one or more actions to assist or protect the people or the property at the site of the emergency situation comprises performing one or more of:
pulling the autonomous vehicle in a driving lane or a shoulder at an angle or straight;
displaying one or more messages on one or more display devices mounted on one or more exterior sides of the autonomous vehicle to alert a passerby of the emergency situation or to request help; or
initiating a two-way communication between the passerby and an agent at a mission control, a police department, a fire department, or an emergency medical services department.

21. The non-transitory CRM of claim 15, wherein the operations further comprising disabling the first responder mode of the autonomous vehicle in response to receiving a command to disable the first responder mode from the computing system.
